(19) United States
(12) Patent Application Publication
(10) Pub. No.: US 2002/0123894 A1
(43) Pub. Date: Sep. 5, 2002

(54) Processing speech recognition errors in an embedded speech recognition system

(75) Inventor: Steven G. Woodward, Boca Raton, FL (US)

Correspondence Address: Gregory A. Nelson, Akerman Santerfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/798,825

(22) Filed: Mar. 1, 2001

(51) Int. Cl. G10L 13/08

(52) U.S. Cl. 704/260

(57) ABSTRACT

A method of processing misrecognized speech in an embedded speech recognition system incorporating a finite state grammar. The method can include the following steps: first, responsive to receiving notification of a misrecognition error, a list of contextually valid phrases in the speech recognition system can be presented to the speaker. Second, a list words can be presented which form a selected one of the contextually valid phrases. Third, one or more selected words in the second presented list can be stored. Notably, the one or more selected words include corrections to said misrecognition error. Finally, the stored words can be processed in a local speech training program. More particularly, the local speech training program can incorporate the corrections into an acoustic model for the embedded speech recognition system.

### BACKGROUND OF THE INVENTION

1. Technical Field

This invention relates to the field of embedded speech recognition systems and more particularly to processing speech recognition errors in an embedded speech recognition system.

2. Description of the Related Art

Speech recognition is the process by which an acoustic signal received by microphone is converted to a set of text words by a computer. These recognized words may then be used in a variety of computer software applications for purposes such as document preparation, data entry, and command and control. Speech recognition systems programmed or trained to the diction and inflection of a single person can successfully recognize the vast majority of words spoken by that person.

In operation, speech recognition systems can model and classify acoustic signals to form acoustic models, which are representations of basic linguistic units referred to as phonemes. Upon receipt of the acoustic signal, the speech recognition system can analyze the acoustic signal, identify a series of acoustic models within the acoustic signal and derive a list of potential word candidates for the given series of acoustic models. Subsequently, the speech recognition system can contextually analyze the potential word candidates using a language model as a guide.

The task of the language model is to express restrictions imposed on the manner in which words can be combined to form sentences. The language model can express the likelihood of a word appearing immediately adjacent to another word or words. Language models used within speech recognition systems typically are statistical models. Examples of well-known language models suitable for use in speech recognition systems include uniform language models, finite state language models, grammar based language models, and m-gram language models.

Notably, the accuracy of a speech recognition system can improve as the acoustic models for a particular speaker are refined during the operation of the speech recognition system. That is, the speech recognition system can observe speech dictation as it occurs and can modify the acoustic model accordingly. Typically, an acoustic model can be modified when a speech recognition training program analyzes both a known word and the recorded audio of a spoken version of the word. In this way, the speech training program can associate particular acoustic waveforms with corresponding phonemes contained within the spoken word.

In traditional computing systems in which speech recognition can be performed, extensive training programs can be used to modify acoustic models during the operation of speech recognition systems. Though time consuming, such training programs can be performed efficiently given the widely available user interface peripherals which can facilitate a user's interaction with the training program. In an embedded computing device, however, typical personal computing peripherals such as a keyboard, mouse, display and graphical user interface (GUI) often do not exist. As such, the lack of a conventional mechanism for interacting with a user can inhibit the effective training of a speech recognition system because such training can become tedious given the limited ability to interact with the embedded system. Yet, without an effective mechanism for training the acoustic model of the speech recognition system when a speech recognition error has occurred, the speech recognition system cannot appropriately update the corresponding speech recognition system language model so as to reduce future instances of future misrecognitions.

### SUMMARY OF THE INVENTION

The present invention solves the problem of processing misrecognized speech in an embedded speech recognition system incorporating a finite state grammar in the following manner: First, responsive to receiving notification of a misrecognition error, a list of contextually valid phrases in the speech recognition system can be presented to the speaker. Second, a list of words can be presented which form a selected one of the contextually valid phrases. Third, one or more selected words in the second presented list can be stored. Notably, the one or more selected words include corrections to the misrecognition error. Finally, the stored words can be processed in a local speech training program. More particularly, the local speech training program can incorporate the corrections into an acoustic model for the embedded speech recognition system.

In one aspect of the invention, the first presenting step can include visually presenting a list of contextually valid phrases in a user interface. Alternatively, the first presenting step can include audibly presenting a list of contextually valid phrases in the speech recognition system. In particular, the step of audibly presenting the list can include first text-to-speech (TTS) converting the list of contextually valid phrases in the speech recognition system; and, second, audibly presenting the TTS converted list. Finally, in yet another aspect of the present invention, the first presenting step can include both visually presenting the list of contextually valid phrases in a visual user interface, and audibly presenting the list of contextually valid phrases in an audio user interface.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic illustration of an embedded computing device configured in accordance with one aspect of the inventive arrangements.

FIG. 2 is a block diagram illustrating an architecture for use in the embedded computing device of FIG. 1.

FIGS. 3A and 3E, taken together, are a pictorial illustration showing a method for processing misrecognized speech in accordance with a second aspect of the inventive arrangements.

FIG. 4 is a flow chart illustrating a process for processing misrecognized speech in the embedded computing device of FIG. 1.

### DETAILED DESCRIPTION OF THE INVENTION

The present invention is a system and method for processing misrecognized speech in an embedded speech recognition system. The method can include speech-to-text converting audio input in the embedded speech recognition system based on an acoustic model. In consequence, the speech-to-text conversion process can produce speech recognized text. The speech-recognized text can be presented to the speaker through a user interface, for example an audio user interface or visual display. Notably, if the speaker detects misrecognized speech, the speaker can notify the speech recognition system of the error. In particular, misrecognized speech can refer to speech recognized text which does not match the actual audio input provided by the speaker. An example of misrecognized speech can include the speech recognized text, “time” resulting from the speaker provided audio input, “climate”.

Responsive to receiving notification of a misrecognition error, a list of contextually valid phrases in the speech recognition system can be presented to the speaker. Contextually valid phrases can include those phrases which would have been valid phrases at the time the speaker provided the audio input. The speaker can select one of the valid phrases which match the speaker's audio input. Subsequently, a list of words can be presented which form the selected phrase. The speaker can select one or more of the words indicating to the speech recognition system which words were misrecognized. Finally, the selected words can be processed in a local speech training program. More particularly, the local speech training program can incorporate the corrections into an acoustic model for the embedded speech recognition system.

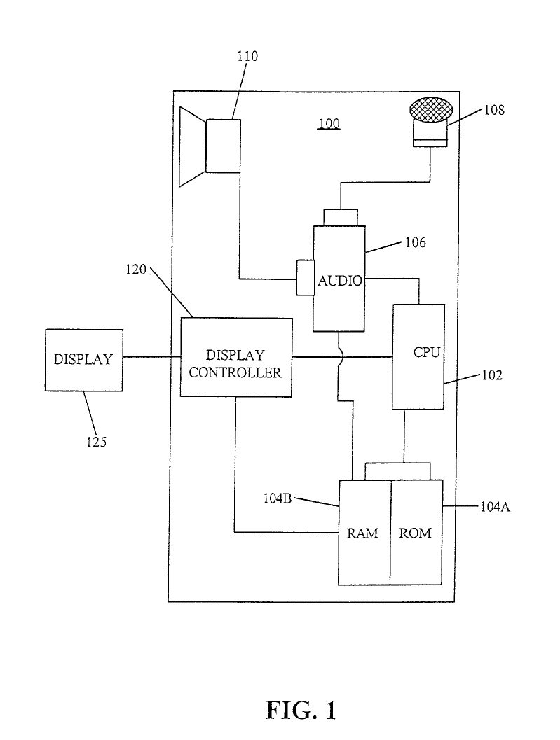

FIG. 1 shows a typical embedded computing device 100 suitable for use with the present invention. The embedded computing device 100 preferably is comprised of a computer including a central processing unit (CPU) 102, one or more memory devices and associated circuitry 104A, 104B. The computing device 100 also can include an audio input device such as a microphone 108 and an audio output device such as a speaker 110, both operatively connected to the computing device through suitable audio interface circuitry 106. The CPU can be comprised of any suitable microprocessor or other electronic processing unit, as is well known to those skilled in the art. Memory devices can include both non-volatile memory 104A and volatile memory 104B. Examples of non-volatile memory can include read-only memory and flash memory. Examples of non-volatile memory can include random access memory (RAM). The audio interface circuitry 106 can be a conventional audio subsystem for converting both analog audio input signals to digital audio data, and also digital audio data to analog audio output signals.

In one aspect of the present invention, a display 125 and corresponding display controller 120 can be provided. The display 125 can be any suitable visual interface, for instance an LCD panel, LED array, CRT, etc. In addition, the display controller 120 can perform conventional display encoding and decoding functions for rendering a visual display based upon digital data provided in the embedded computing device 100. Still, the invention is not limited in regard to the use of the display 125 to present visual feedback to a speaker. Rather, in an alternative aspect, an audio user interface (AUI) can be used to provide audible feedback to the speaker in place of the visual feedback provided by the display 125 and corresponding display controller 120. Moreover, in yet another alternative aspect, feedback can be provided to the speaker through both an AUI and the display 125. Notably, a user input device, such as a keyboard or mouse is not shown, although the invention is not limited in this regard. Rather, the embedded computing device can permit user input through any suitable means including a compact keyboard, physical buttons, pointing device, a touchscreen, audio input device, etc.

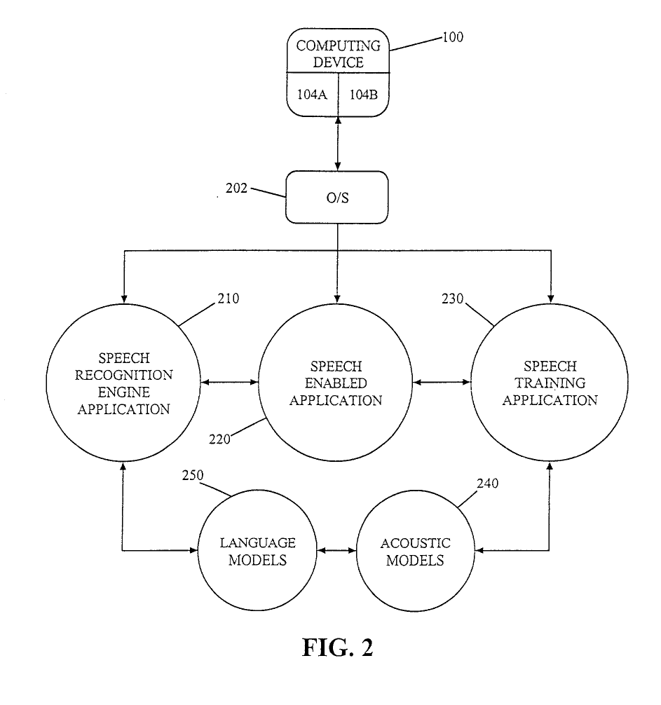

FIG. 2 illustrates a typical high level architecture for the embedded computing device of FIG. 1. As shown in FIG. 2, an embedded computing device 100 for use with the invention typically can include an operating system 202, a speech recognition engine 210, a speech enabled application 220 and speech training application 230. Acoustic models 240 also can be provided for the benefit of the speech recognition engine 210. Acoustic models 240 can include phonemes which can be used by the speech recognition engine 210 to derive a list of potential word candidates within the language model 250 from an audio speech signal. Importantly, speech training application 230 can access the acoustic models 240 in order to modify the same during a speech training session. By modifying the acoustic models 240 during a speech training session, the accuracy of the speech recognition engine 210 can increase as fewer misrecognition errors can be encountered during a speech recognition session.

Notably, in FIG. 2, the speech recognition engine 210, speech enabled application 220 and speech training application 230 are shown as separate application programs. It should be noted however that the invention is not limited in this regard, and these various application programs could be implemented as a single, more complex applications program. For example the speech recognition engine 210 could be combined with the speech enabled application 220.

Referring now to both FIGS. 1 and 2, during a speech recognition session, audio signals representative of sound received in microphone 108 are processed by CPU 102 within embedded computing device 100 using audio circuitry 106 so as to be made available to the operating system 202 in digitized form. The audio signals received by the embedded computing device 100 are conventionally provided to the speech recognition engine 210 via the computer operating system 202 in order to perform speech-to-text conversions on the audio signals which can produce speech recognized text. In sum, as in conventional speech recognition systems, the audio signals are processed by the speech recognition engine 210 using an acoustic model 240 and language model 250 to identify words spoken by a user into microphone 108.

Once audio signals representative of speech have been converted to speech recognized text by the speech recognition engine 210, the speech recognized text can be provided to the speech enabled application 220 for further processing. Examples of speech enabled applications can include a speech-driven command and control application, or a speech dictation system, although the invention is not limited to a particular type of speech enabled application. The speech enabled application, in turn, can present the speech recognized text to the user through a user interface. For example, the user interface can be a visual display screen, an LCD panel, a simple array of LEDs, or an AUI which can provide audio feedback through speaker 110.

In any case, responsive to the presentation of the speech recognized text, a user can determine whether the speech recognition engine 210 has properly speech-to-text converted the user's speech. In the case where the speech recognition engine 210 has improperly converted the user's speech into speech recognized text, a speech misrecognition is said to have occurred. Importantly, where the user identifies a speech misrecognition, the user can notify the speech recognition engine 210. Specifically, in one aspect of the invention, the user can activate an error button which can indicate to the speech recognition engine that a misrecognition has occurred. However, the invention is not limited in regard to the particular method of notifying the speech recognition engine 210 of a speech misrecognition. Rather, other notification methods, such as providing a speech command can suffice.

Responsive to receiving a misrecognition error notification, the speech recognition engine 210 can store the original audio signal which had been misrecognized, and a reference to the active language model. Additionally, a list of contextually valid phrases in the speech recognition system can be presented to the speaker. Contextually valid phrases can include those phrases in a finite state grammar system which would have been valid phrases at the time of the misrecognition. For example, a speech-enabled word processing system, while editing a document, a valid phrase could include, “Close Document”. By comparison, in the same word processing system, prior to opening a document for editing, an invalid phrase could include “Save Document”. Hence, if a misrecognition error had been detected prior to opening a document for editing, the phrase “Save Document” would not be included in a list of contextually valid phrases, while the phrase “Open Document” would be included in a list of contextually valid phrases.

Once the list of contextually valid phrases has been presented to the speaker, the speaker can select one of the phrases as the phrase actually spoken by the speaker. Subsequently, a list of words can be presented which form the selected phrase. Again, the speaker can select one or more words in the list which represent those words originally spoken by the speaker, but misrecognized by the speech recognition engine.

These words can be processed along with the stored audio input and the active language model by the speech training application 230. More particularly, the speech training application 230 can incorporate corrections into acoustic models 240 based on the specified correct words.

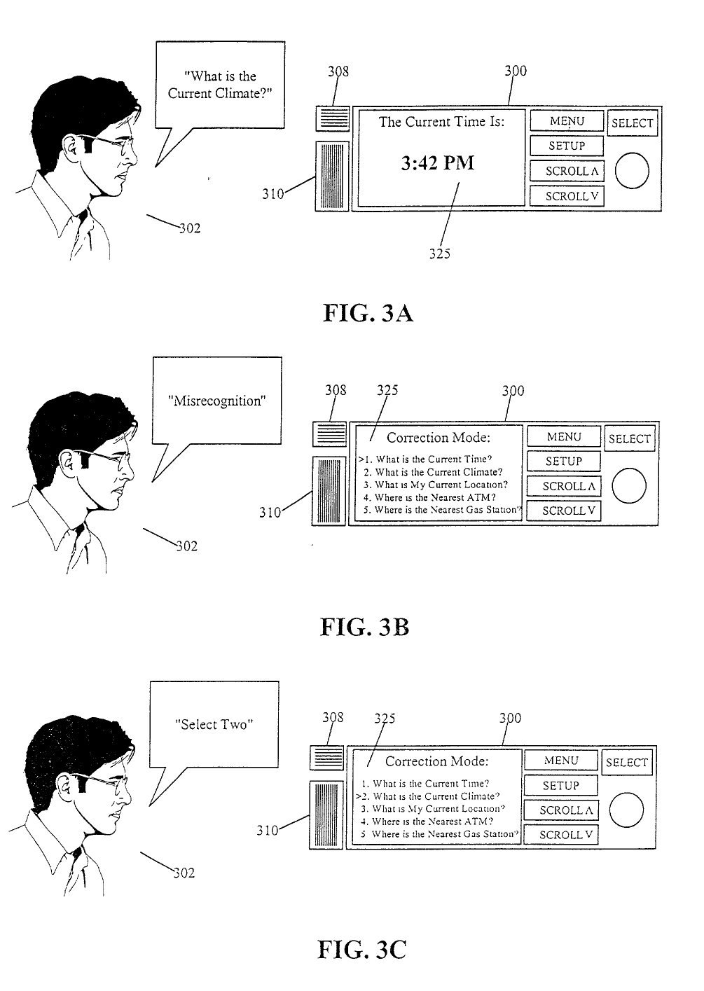

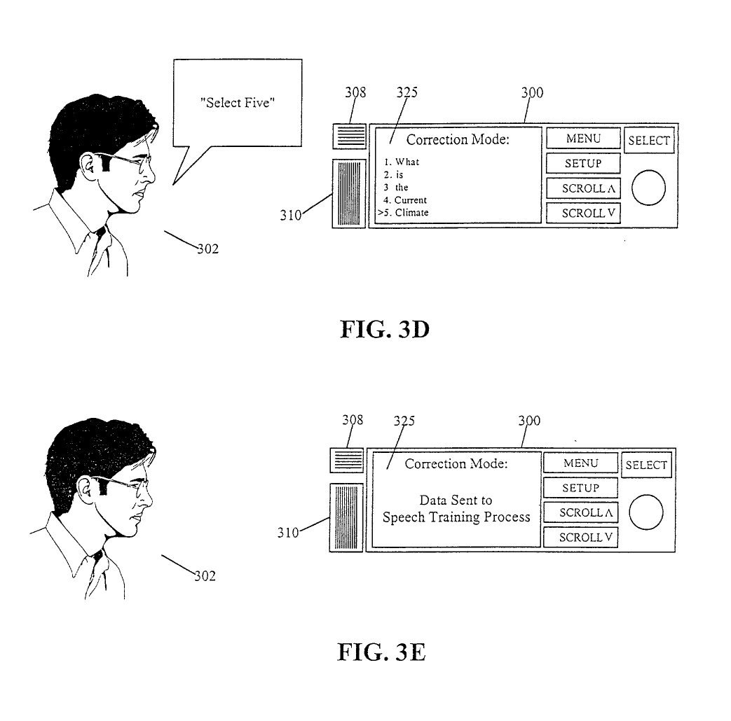

FIGS. 3A and 3B, taken together, are a pictorial illustration depicting an exemplary application of a method for processing a misrecognition error in an embedded speech recognition system. Referring first to FIG. 3A, a speaker 302 can provide a speech command to a speech-enabled vehicle computer 300 through microphone 308. Importantly, in the illustrated example, the speech-enabled vehicle computer 300 can provide speaker feedback both through a visual display 325 and through an AUI. In the case of the AUI, audio feedback is provided through the speaker 310. As shown in FIG. 3A, the speaker 302 requests the current exterior climate, for example the exterior temperature, by providing the speech command, “What is the Current Climate?”. In response, the speech-enabled vehicle computer 300 displays the current time as “3:42 PM”.

In FIG. 3B, the speaker detects a misrecognition error (the speaker asked for the current climate, not the current time) and notifies the speech-enabled vehicle computer 300 that a misrecognition error has occurred. In response, the speech-enabled vehicle computer 300 enters a speech correction mode in which a list of contextually valid phrases is provided through the display 325. In addition, the speech-enabled vehicle computer 300 can audibly recite each phrase in the list. In FIG. 3C, the speaker can select the actual phrase spoken, either audibly, for instance by saying, “Select Two”, or physically, for instance by manipulating physical user interface controls as shown in the figure. In the instant case, the speaker 302 can select the actually spoken phrase, “What is the Current Climate?”.

In FIG. 3D, the speech-enabled vehicle computer 300 can provide a list of words which form the selected phrase. In the instant case, the words, “What”, “is”, “the”, “Current” and “Climate” are presented in the display 325. The speaker 302 can select each word actually spoken, but misrecognized as another word by the speech-enabled vehicle computer 300. In the instant case, realizing that the word “Climate” had been mistaken for the word “Time”, the speaker can select the word “Climate” by saying, “Select Five”. Subsequently, in FIG. 3E, the selected word “Climate” can be provided to a speech training application, along with the originally recorded speech, “What is the Current Climate.” The speech training application, in turn, can use the originally recorded audio and the selected word “Climate” to modify corresponding acoustic models appropriately. As a result, the recognition accuracy of the speech-enabled vehicle computer 300 can improve.

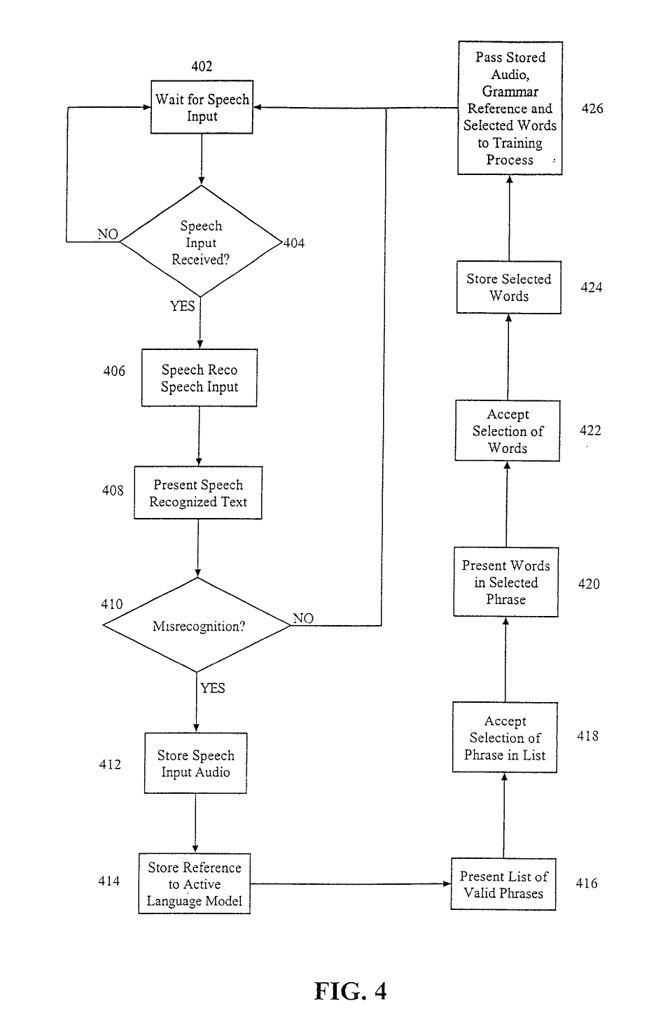

FIG. 4 is a flow chart illustrating a method for processing a misrecognition error in an embedded speech recognition system during a speech recognition session. The method can begin in step 402 in which a speech-enabled system can await speech input. In step 404, if speech input is not received, the system can continue to await speech input. Otherwise, in step 406 the received speech input can be speech-to-text converted in a speech recognition engine, thereby producing speech recognized text. In step 408, the speech recognized text can be presented through a user interface such as a visual or AUI. Subsequently, in step 410 if an error notification is not received, such notification indicating that a misrecognition has been identified, it can be assumed that the speech recognition engine correctly recognized the speech input. As such, the method can return to step 402 in which the system can await further speech input. In contrast, if an error notification is received, indicating that a misrecognition has been identified, in step 412 the speech input can be stored. Moreover, in step 414 a reference to the presently active language model can be stored. In consequence, at the conclusion of the speech recognition session, both the stored speech input and reference to the active language model can be used by an associated training session to update the language model in order to improve the recognition capabilities of the speech recognition system.

In step 416, a list of contextually valid phrases can be presented through the user interface indicating those phrases which would be considered valid speech input at the time of the misrecognition. In step 418, a phrase can be selected from among the phrases in the list. In step 420, the words forming the selected phrase can be presented in a list of words through the user interface. In step 422, one or more of the words can be selected, thereby indicating those words which had been misrecognized by the speech recognition engine. In step 424, the selected words can be stored pending transmission to a speech training application. Specifically, in step 426 the stored words, audio input and language model reference can be provided to the speech training application. In consequence, the speech training application can modify corresponding acoustic models and language models in order to improve future recognition accuracy.

Notably, the present invention can be realized in hardware, software, or a combination of hardware and software. The method of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which when loaded in a computer system is able to carry out these methods. Computer program means, or computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

I claim:

1. In an embedded speech recognition system incorporating a finite state grammar, a method for processing misrecognized speech comprising:
responsive to receiving notification of a misrecognition error, first presenting a list of contextually valid phrases in the speech recognition system;
second presenting a list of words which form a selected one of said contextually valid phrases;
storing one or more selected words in said second presented list, said one or more selected words comprising corrections to said misrecognition error; and,
processing said stored words in a local speech training process, said process incorporating said corrections into an acoustic model for the embedded speech recognition system.

2. The method of claim 1, wherein said first presenting step comprises visually presenting a list of contextually valid phrases in a user interface.

3. The method of claim 1, wherein said first presenting step comprises audibly presenting a list of contextually valid phrases in the speech recognition system.

4. The method of claim 2, wherein said first presenting step further comprises audibly presenting a list of contextually valid phrases in the speech recognition system.

5. The method of claim 3, wherein said step of audibly presenting said list comprises:
text-to-speech (TTS) converting said list of contextually valid phrases in the speech recognition system; and,
audibly presenting said TTS converted list.

6. A machine readable storage, having stored thereon a computer program for processing misrecognition speech in an embedded speech recognition system, said computer program having a plurality of code sections executable by a machine for causing the machine to perform the steps of:
responsive to receiving notification of a misrecognition error, first presenting a list of contextually valid phrases in the speech recognition system;
second presenting a list words which form a selected one of said contextually valid phrases;
storing one or more selected words in said second presented list, said one or more selected words comprising corrections to said misrecognition error; and,
processing said stored words in a local speech training process, said process incorporating said corrections into an acoustic model for the embedded speech recognition system.

7. The machine readable storage of claim 6, wherein said first presenting step comprises visually presenting a list of contextually valid phrases in a user interface.

8. The machine readable storage of claim 6, wherein said first presenting step comprises audibly presenting a list of contextually valid phrases in the speech recognition system.

9. The machine readable storage of claim 7, wherein said first presenting step further comprises audibly presenting a list of contextually valid phrases in the speech recognition system.

10. The machine readable storage of claim 8, wherein said step of audibly presenting said list comprises:
text-to-speech (TTS) converting said list of contextually valid phrases in the speech recognition system; and,
audibly presenting said TTS converted list.
